(19) United States
(12) Patent Application Publication
(10) Pub. No.: US 2010/0054334 A1
(43) Pub. Date: Mar. 4, 2010

(54) METHOD AND APPARATUS FOR DETERMINING A PREDICTION MODE

(75) Inventors: Ki-won YOO, Seoul (KR); Tae-gyoung AHN, Suwon-si (KR); Jae-hun LEE, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/431,797

(22) Filed: Apr. 29, 2009

(30) Foreign Application Priority Data
Sep. 2, 2008 (KR) 10-2008-0086284

(51) Int. Cl. H04N 7/12

(52) U.S. Cl. 375/240.14; 375/E07.001

(57) ABSTRACT

A method and apparatus for determining a prediction mode which is used during encoding of a current block is provided. In the method and apparatus, a prediction mode candidate group to be used for the current block is determined based on a prediction mode for a block positioned at the same location on a reference picture as a location of the current block encoded, predictive coding is performed on the current block by using predictive modes included in the prediction mode candidate group. Thus, image prediction efficient is improved, and the time and number of calculations required for prediction mode determination are reduced.

### CROSS-REFERENCE TO RELATED PATENT APPLICATION

This application claims priority from Korean Patent Application No. 10-2008-0086284, filed on Sep. 2, 2008, in the Korean Intellectual Property Office, the disclosure of which is incorporated herein in its entirety by reference.

### BACKGROUND OF THE INVENTION

1. Field of the Invention

Methods and apparatuses consistent with the present invention relate to determination of a prediction mode, and more particularly, to determining a prediction mode to be actually used among a plurality of available prediction modes.

2. Description of the Related Art

In image compression methods such as MPEG-1, MPEG-2, MPEG-4, H.264/MPEG-4 AVC (Advanced Video Coding), etc., a single picture is divided into macroblocks in order to encode an image. The macroblocks may be encoded using prediction modes that are available for use in interprediction and intraprediction. A prediction mode is selected based on a bit rate required to encode a macroblock and the degree of distortion between the original macroblock and the encoded macroblock, and then all the macroblocks are encoded using the selected prediction mode.

Macroblocks are encoded in two types of prediction modes, namely, an inter mode and an intra mode. In the inter mode, a macroblock of a current picture is encoded by encoding motion vector information representing locations of reference blocks selected from at least one reference picture and a difference between the macroblock and each of the reference blocks. In an intra mode, a macroblock of a current picture is encoded by calculating a prediction value of the to-be-encoded macroblock by using a value of a pixel spatially adjacent to the to-be-encoded macroblock and then by encoding a difference between the prediction value and the original pixel value.

In H.264/MPEG-4 AVC, when a motion vector of a macroblock included in a P slice is the same as a predicted motion vector, or a motion vector of a macroblock included in a B slice is the same as a direct motion vector, there exists a skip mode in which a macroblock is encoded using only a 1-bit flag. During predictive coding of images, costs incurred by various prediction modes are calculated by actually applying all of the various prediction modes, and a prediction mode generating a minimum cost is determined. Thus, this prediction mode determination requires much time and many calculations.

### SUMMARY OF THE INVENTION

Methods and apparatuses consistent with the present invention provide a method and apparatus for determining a prediction mode, in which a prediction mode for a current block is predicted based on information about a prediction mode for a previously-encoded reference picture so that image prediction efficiency is improved and also the time required for prediction mode determination and the number of calculations performed for prediction mode determination are reduced.

According to an aspect of the present invention, there is provided a method of determining a prediction mode for an image, the method including: checking a reference prediction mode for a reference block positioned at a location on a reference picture that is the same as a location of a current block of a current picture to be encoded; determining a first prediction mode candidate group to be used for the current block, according to a type of the reference prediction mode, performing predictive coding on the current block using prediction modes included in the first prediction mode candidate group; and determining a first prediction mode, having a smallest error value from among the prediction modes included in the first prediction mode candidate group, as a prediction mode to be used for the current block.

According to another aspect of the present invention, there is provided an apparatus for determining a prediction mode for an image, the apparatus comprising: a first prediction mode candidate group determination unit which determines a first prediction mode candidate group to be used for a current block of a current picture to be encoded, the first prediction mode candidate group being determined according to a type of a prediction mode of a reference block positioned at a location on a reference picture that is the same as a location of the current block of the current picture; and a final prediction mode determination unit which determines a first prediction mode, having a smallest error value from among prediction modes included in the first prediction mode candidate group, as a prediction mode to be used for the current block, wherein the first prediction mode is determined according to results of predictive coding operations on the current block based on the prediction modes included in the first prediction mode candidate group.

According to another aspect of the present invention, there is provided an image decoding method including: receiving a bitstream obtained by encoding based on a prediction mode which provides a smallest prediction error value from among prediction modes included in a prediction mode candidate group determined according to a prediction mode for a reference block at a location on a reference picture that is the same as a location of a current block on a current picture; generating residual data for the current block by performing entropy decoding, dequantization, and inverse transformation on the received bitstream; generating a prediction block for the current block by applying the prediction mode which provides the smallest prediction error value; and decoding the current block by adding the current block to the prediction block.

According to another aspect of the present invention, there is provided an image decoding apparatus including: an entropy decoding unit which receives a bitstream obtained by encoding based on a prediction mode which provides a smallest prediction error value from among prediction modes included in a prediction mode candidate group determined according to a prediction mode for a reference block at a location on a reference picture that is the same as a location of a current block and which performs entropy decoding on the received bitstream; a dequantization and inverse transformation unit which generates residual data for the current block by performing dequantization, and inverse transformation on the entropy-decoded bitstream; a prediction unit which generates a prediction block for the current block by applying the prediction mode which provides the smallest prediction error value, wherein the prediction mode is extracted from the bitstream; and an addition unit which decodes the current block by adding the current block to the prediction block.

In a prediction mode determining method and apparatus consistent with the present invention, image prediction efficiency is improved, and the number of prediction modes actually applied is reduced, so that the time and number of calculations required for prediction mode determination can be reduced.

### BRIEF DESCRIPTION OF THE DRAWINGS

The above and other features and advantages of the present invention will become more apparent by describing in detail exemplary embodiments thereof with reference to the attached drawings in which:

FIG. 1 is a reference diagram for illustrating a block prediction mode according to an exemplary embodiment of the present invention;

FIG. 2 is a reference diagram for illustrating an example of hierarchical B pictures having a dyadic hierarchy structure;

FIG. 3 is a reference diagram for illustrating an example of hierarchical B pictures having no dyadic hierarchy structures;

FIG. 4 is a block diagram of an image encoding apparatus according to an exemplary embodiment of the present invention;

FIG. 5 is a block diagram of a prediction mode determination unit of the image encoding apparatus illustrated in FIG. 4;

FIG. 6 is a reference diagram for illustrating a prediction mode determining process performed by the prediction mode determination unit illustrated in FIG. 5;

FIG. 7 is a flowchart of a prediction mode determining method according to an exemplary embodiment of the present invention;

FIG. 8 is a flowchart of a first prediction mode candidate group determining operation included in the prediction mode determining method illustrated in FIG. 7; and

FIG. 9 is a block diagram of an image decoding apparatus according to an exemplary embodiment of the present invention.

### DETAILED DESCRIPTION OF EXEMPLARY EMBODIMENTS OF THE INVENTION

The present invention will now be described more fully with reference to the accompanying drawings, in which exemplary embodiments of the invention are shown.

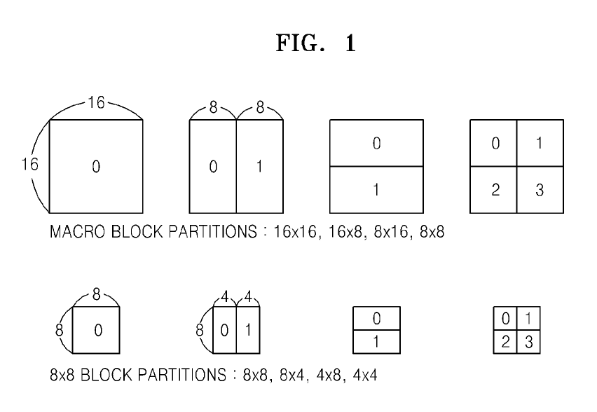

FIG. 1 is a reference diagram for illustrating a block prediction mode according to an exemplary embodiment of the present invention.

As shown in FIG. 1, a macroblock may be divided into subblocks of various sizes, such as, 16×16, 16×8, 8×16, 8×8, 8×4, 4×8, and 4×4, and the subblocks may be encoded. Each macroblock is encoded using various prediction modes that can be used in interprediction and intraprediction, and a prediction mode that generates a minimum cost, for example, a minimum rate-distortion (RD) cost, from among the various prediction modes used to encode each macroblock is determined as a final prediction mode for the macroblock. More specifically, during intraprediction, a macroblock is predictively coded in each of an intra 16×16 mode, an intra 8×8 mode, an intra 4×4 mode, etc. During interprediction, a macroblock is encoded in a prediction mode selected from among a 16×16 mode, a 16×8 mode, a 8×16 mode, a 8×8 mode, a 8×4 mode, a 4×8 mode, a 4×4 mode as illustrated in FIG. 1, or encoded in skip mode. Skip mode is a mode in which only information about a prediction mode of a current block is encoded. In skip mode, data such as a residual signal or motion vector information is not encoded, and only prediction mode information representing skip mode is transmitted through a 1-bit flag. In a decoder, when a current block to be decoded is encoded in skip mode at an encoder, a predictive motion vector of the current block is determined using motion vectors of neighboring blocks, and a motion-compensation value obtained using the predictive motion vector is used as a prediction value for a block to be decoded.

According to the related art, as described above, each macroblock is encoded in all prediction modes that can be used in interprediction and intraprediction, and then a prediction mode that generates a minimum cost is determined as a final prediction mode for each macroblock. The prediction mode determination according to the related art requires much time and many calculations. Thus, the present invention provides a method and apparatus for determining a prediction mode, by which a prediction mode for a current block which is to be encoded can be efficiently determined using information about a prediction mode for a previously-encoded reference picture.

A structure of a group of pictures (GOP) to which a prediction mode determining method and apparatus according to the present invention is applied will now be described, before the prediction mode determining method and apparatus according to the present invention is described.

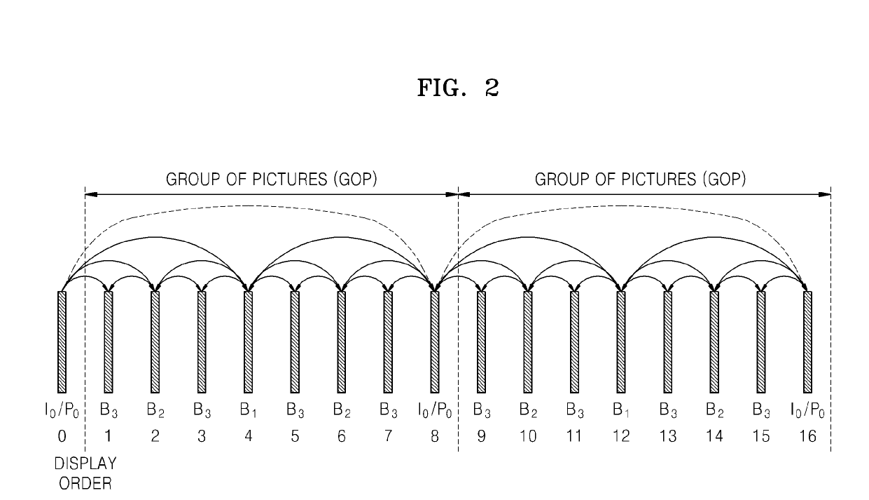

FIG. 2 is a reference diagram for illustrating an example of hierarchical B pictures having a dyadic hierarchy structure.

Referring to FIG. 2, an image located at the start of an image sequence in a hierarchical B-picture structure (which is also called a pyramid picture structure) is encoded as an intra picture called an instantaneous decoding refresh (IDR) picture. A picture located at the end of a GOP is referred to as a key picture and may be encoded as an I picture or a P picture. In a process of encoding each picture of a GOP, first, picture B₁ is predictively encoded by referring to the IDR picture located at the head of the GOP and the key picture at the tail of the GOP. Then, picture B₂ is predictively encoded by referring to other pictures indicated by arrows in FIG. 2. Then, picture B₃ is predictively encoded by referring to other pictures indicated by arrows in FIG. 2.

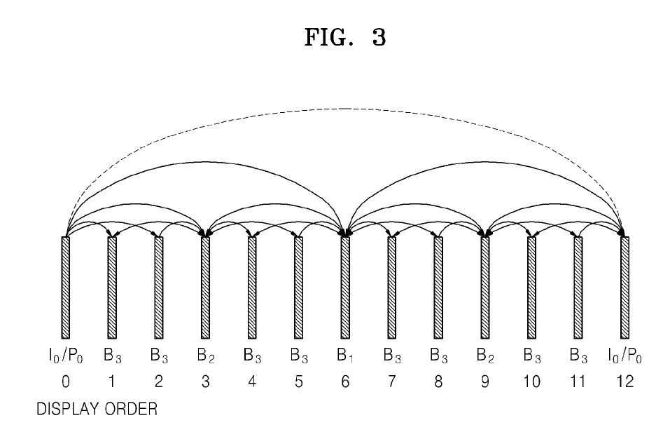

FIG. 3 is a reference diagram for illustrating an example of hierarchical B pictures that do not form a dyadic hierarchy structure. In this case, since a frame rate is changed due to various circumstances, a GOP may not be dyadically constructed. Referring to FIG. 3, in hierarchical B pictures that do not form a dyadic hierarchical structure, picture B₁ is predictively encoded by referring to an IDR picture and a key picture at the tail of a GOP, which is similar to the process for the GOP of FIG. 2. Then, picture B₂ is predictively encoded by referring to other pictures indicated by arrows on FIG. 3. Then, picture B₃ is predictively encoded by referring to other pictures indicated by arrows in FIG. 3.

A predictive mode determining method and apparatus according to the present invention may be applied to a B picture at the highest level, that is, picture B₃ in the hierarchical B-picture structure as described above, because the B picture at the highest level in the hierarchical B-picture structure is not used as a reference picture for other pictures and thus can prevent propagation of errors generated during inter prediction. However, the predictive mode determining method and apparatus according to the present invention may not only be applied to picture B₃ at the highest level in the hierarchical B-picture structure but also to both pictures B₁ and B₃ of FIGS. 2 and 3. The predictive mode determining method and apparatus according to the present invention may be used to determine a prediction mode for blocks included in a B or P picture of a general form of GOP such as IB . . . B . . . BP or IP . . . P . . . P.

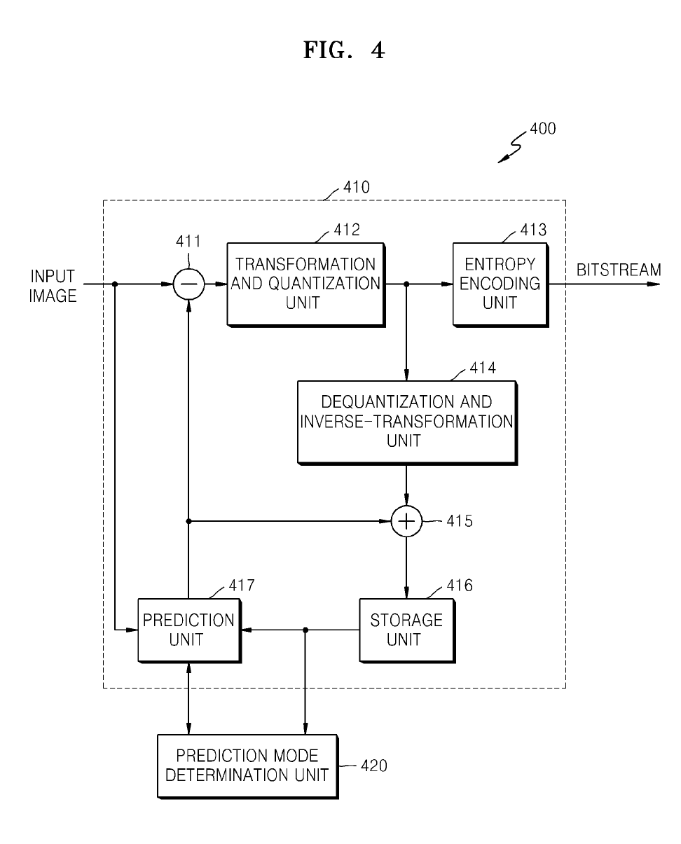

FIG. 4 is a block diagram of an image encoding apparatus 400 according to an exemplary embodiment of the present invention. Referring to FIG. 4, the image encoding apparatus 400 includes an encoding unit 410 and a prediction mode determination unit 420.

The encoding unit 410 includes a subtractor 411, a transformation and quantization unit 412, an entropy encoding unit 413, a dequantization and inverse-transformation unit 414, an adder 415, a storage unit 416, and a prediction unit 417. The encoding unit 410 divides an input image into a plurality of macroblocks, performs intraprediction and interprediction with respect to each of the macroblocks in order to generate a prediction image, and transforms, quantizes, and entropy-encodes a difference between the prediction image and the input image, thereby generating a bitstream.

More specifically, the prediction unit 417 divides the input image into a plurality of predetermined-sized blocks and performs intraprediction and interprediction with respect to each of the blocks in order to generate a prediction block. At this time, the prediction unit 417 performs predictive coding using only the predictive modes included in prediction mode candidate groups that the prediction mode determination unit 420 has determined based on information about a prediction mode of a previously-encoded reference picture when the blocks included in a B picture or a P picture are encoded as will be described later.

The subtractor 411 generates residual data corresponding to a difference between the prediction block obtained by the prediction unit 417 and the original block. The transformation and quantization unit 412 transforms the residual data into a frequency domain and quantizes the residual data. The entropy encoding unit 413 performs variable length coding (VLC) on a result of the quantization so as to generate the bitstream.

The dequantization and inverse-transformation unit 414 performs dequantization and inverse transformation on the transformed and quantized residual data so as to restore the original residual data. The adder 415 adds a prediction block of the current block to the restored residual data so as to restore the current block. The restored current block is stored in the storage unit 416 and used as reference data for the next block.

The prediction mode determination unit 420 determines a prediction mode candidate group to be used for the blocks included in a current picture which is currently encoded, using information about a prediction mode for a previously encoded reference picture. As described above, the prediction unit 417 performs predictive coding on the current block by using only the prediction modes included in the prediction mode candidate group. The prediction mode determination unit 420 calculates costs required during use of the prediction modes and determines a prediction mode generating a minimum cost as a prediction mode for the current block which is currently encoded.

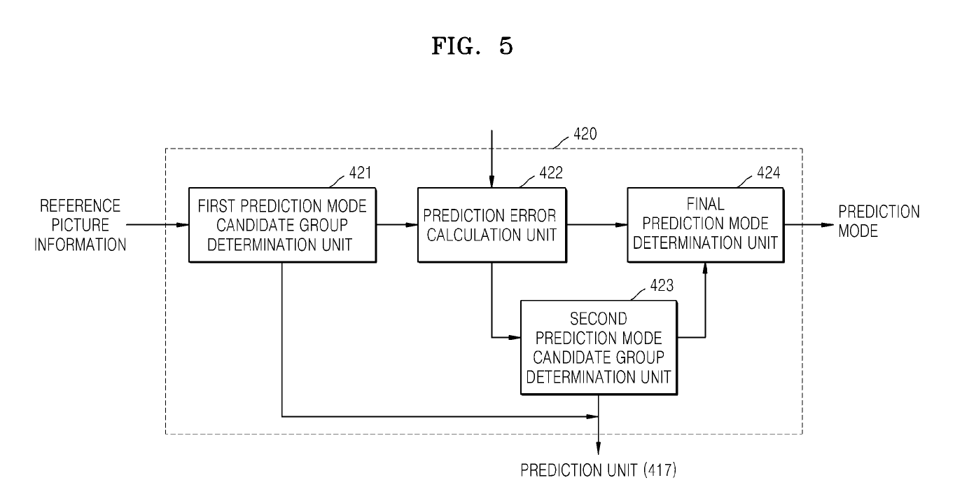

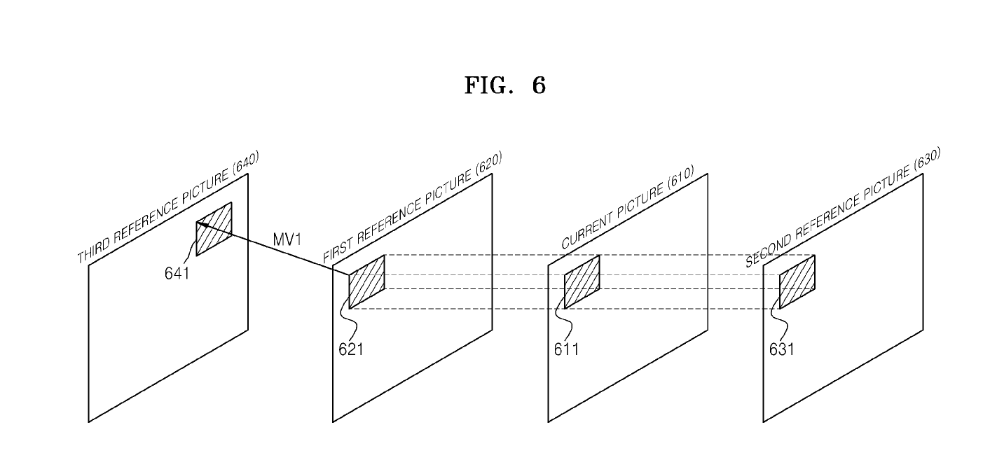

FIG. 5 is a block diagram of the prediction mode determination unit 420. FIG. 6 is a reference diagram for illustrating a prediction mode determining process performed by the prediction mode determination unit 420.

Referring to FIG. 5, the prediction mode determination unit 420 includes a first prediction mode candidate group determination unit 421, a prediction error calculation unit 422, a second prediction mode candidate group determination unit 423, and a final prediction mode determination unit 424.

The first prediction mode candidate group determination unit 421 determines a first prediction mode candidate group to be actually applied for the current block according to the type of a prediction mode of a block positioned at the same location on a reference picture as the location of the current block of the current picture which is encoded. This determination is based on the statistical fact that prediction modes of the current block of the currently-encoded current picture and the block having the same location on the previously-encoded reference picture as the currently-encoded current block are highly likely to be similar. In an exemplary embodiment, the first prediction mode candidate group depending on the prediction mode of the block positioned at the same location on the reference picture as the location of the current block of the current picture is as illustrated in Table 1. In Table 1, Paxb (where a and b are positive integers) denotes an inter axb mode in which interprediction is performed on an axb-sized block.

TABLE 1

| Prediction mode | | Second |
|---|---|---|
| of block of | First prediction mode | prediction mode |
| reference picture | candidate group | candidate group |
| Skip mode | skip mode | P16 × 16 |
| P16 × 16 | skip mode, P16 × 16 | P8 × 8, intra mode |
| P16 × 8 | skip mode, P16 × 16, P16 × 8 | P8 × 8, intra mode |
| P8 × 16 | skip mode, P16 × 16, P8 × 16 | P8 × 8, intra mode |
| P8 × 8 | skip mode, P16 × 16, P8 × 8 | intra mode |
| intra mode | skip mode, P16 × 16 | P8 × 8, intra mode |

Referring to Table 1, when the prediction mode of the block at the same location on the reference picture as that of the current block of the current picture is skip mode, the first prediction mode candidate group determination unit 421 determines skip mode as the component mode of the first prediction mode candidate group to be actually applied for the current block. When the prediction mode of the block at the same location on the reference picture as that of the current block of the current picture is an inter M×N (where M and N are integers) mode, the first prediction mode candidate group determination unit 421 determines skip mode and an interprediction mode(s) that uses a block with a size the same as or larger than the size of an M×N block used in the inter M×N mode, as the component modes of the first prediction mode candidate group to be actually applied for the current block. For example, if the prediction mode of the block at the same location on the reference picture as that of the current block of the current picture is a P16×8 mode, the first prediction mode candidate group determination unit 421 determines only a skip mode, a P16×16 mode, and a P16×8 mode as the component modes of the first prediction mode candidate group to be actually applied for the current block. When the prediction mode of the block at the same location on the reference picture as that of the current block of the current picture is an intra mode, the first prediction mode candidate group determination unit 421 determines skip mode and the P16×16 mode as the component modes of the first prediction mode candidate group to be actually applied for the current block. When the prediction mode of the block at the same location on the reference picture as that of the current block of the current picture is not any of the prediction modes listed in Table 1, the current block is predictively encoded using all available prediction modes as in the conventional art.

In an exemplary embodiment, referring to FIG. 6, the first prediction mode candidate group determination unit 421 checks the prediction modes of blocks at the same locations on reference pictures as that of a current block 611 of a current picture 610. If the current picture 610 is a B picture that uses two reference pictures, namely, a first reference picture 620 and a second reference picture 630, the first prediction mode candidate group determination unit 421 determines a reference block providing the lowest cost from among a first reference block 621 of the first reference picture 620 and a second reference block 631 of the second reference picture 630, as a reference block to be used in determination of the prediction mode for the current block 611. The first and second reference blocks 621 and 631 are at the same location as that of the current block 611. In this exemplary embodiment, it is assumed that the first reference block 621 of the first reference picture 620 generates a smaller cost, for example, a smaller sum of absolute difference (SAD), than that of the second reference block 631. Then, the first prediction mode candidate group determination unit 421 determines the first prediction mode candidate group to be used for the current block 611 as illustrated in Table 1, by using the prediction mode for the first reference block 621 which has been previously encoded. For example, if the prediction mode for the first reference block 621 is a P16×8 mode, the first prediction mode candidate group determination unit 421 determines only a skip mode, a P16×16 mode, and a P16×8 mode as the component modes of the first prediction mode candidate group which is to be actually used for the current block 611, according to Table 1.

Information about the first prediction mode candidate group determined by the first prediction mode candidate group determination unit 421 is transmitted to the prediction unit 417. The prediction unit 417 performs predictive coding on the current block by using each of the prediction modes included in the first prediction mode candidate group.

The final prediction mode determination unit 424 determines a first prediction mode having the smallest error value from among the prediction modes included in the first prediction mode candidate group, according to results of the predictive coding operations on the current block in the prediction modes included in the first prediction mode candidate group. The error value or the cost may be calculated using an SAD, a sum of absolute transformed difference (SATD), a sum of squared difference (SSD), a mean of absolute difference (MAD), or a LaGrange function.

Additionally, the prediction error calculation unit 422 may calculate a first error value between the current block and a prediction block for the current block, which is obtained by the first prediction mode, and a second error value between the block at the same location on the reference picture as that of the current block and a prediction block used during encoding of the block at the same location on the reference picture as that of the current block. Referring back to FIG. 6, it is assumed that the first reference block 621 is a reference block used to determine the first prediction mode candidate group for the current block 611 and that a reference block used in encoding of the first reference block 621 is a third reference block 641 of the third reference picture 640. In this case, the first error value indicates an error value between the current block 611 and a prediction block for the current block 611 which is obtained in the first prediction mode, and the second error value indicates an error value between the second reference block 631 and the third reference block 641 corresponding to a prediction block for the second reference block 631. As described above, the first error value and the second error value may be calculated using various cost functions such as an SAD.

The second prediction mode candidate group determination unit 423 compares the first error value with the second error value.

When the first error value is greater than the second error value, the second prediction mode candidate group determination unit 423 determines a second prediction mode candidate group to be additionally used for the current block, according to the prediction mode for the block at the same location on the reference picture as that of the current block. An exemplary embodiment of the second prediction mode candidate group to be additionally used for the current block, depending on the type of the prediction mode for the block at the same location on the reference picture as that of the current block, is illustrated in Table 1. In other words, when the prediction mode for the block at the same location on the reference picture as that of the current block is skip mode, the second prediction mode candidate group determination unit 423 determines an inter 16×16 mode as the component modes of the second prediction mode candidate group to be additionally used for the current block. When the prediction mode for the block at the same location on the reference picture as that of the current block is a P16×16, P16×8, or P8×16 mode, the second prediction mode candidate group determination unit 423 determines an intra mode and an inter 8×8 mode as the component modes of the second prediction mode candidate group. When the prediction mode for the block at the same location on the reference picture as that of the current block is a P8×8 mode, the second prediction mode candidate group determination unit 423 determines the intra mode as the component modes of the second prediction mode candidate group. When the prediction mode for the block at the same location on the reference picture as that of the current block is the intra mode, the second prediction mode candidate group determination unit 423 determines the inter 8×8 mode and the intra mode as the component modes of the second prediction mode candidate group.

On the other hand, when the first error value is less than or equal to the second error value, the final prediction mode determination unit 424 determines the first prediction mode as the final prediction mode for the current block without applying the second prediction mode candidate group.

Information about the second prediction mode candidate group determined by the second prediction mode candidate group determination unit 423 is transmitted to the prediction unit 417. The prediction unit 417 performs predictive coding on the current block by using each of the prediction modes included in the second prediction mode candidate group.

The final prediction mode determination unit 424 determines a second prediction mode having the smallest error value from among the prediction modes included in the second prediction mode candidate group, and determines a prediction mode corresponding to a prediction block having a smaller error value from among prediction blocks of the current block which are obtained in the first prediction mode and the second prediction mode, as the final prediction mode for the current block. The error value is a difference between the current block and a prediction block for the current block.

When calculating the first and second error values, the prediction error calculation unit 422 may compensate for the first error value and the second error value by compensating for a quantization error which is generated during quantization. As described above, the encoding unit 410 transforms, quantizes, and entropy-encodes the residual data which is a difference between a currently encoded block and a prediction block obtained according to a prediction mode. During the quantization, quantization steps used to quantize blocks may have different sizes. Thus, when the first error value and the second error value are calculated, any difference between quantization steps needs to be compensated for.

In general, as quantization parameter (QP) increases by 6 stages, the value of a quantization step Qstep doubles. In other words, a quantization step size p[r] (where r is one of quantization parameters k+1 (k is an integer) through k+6) of 6 consecutive quantization parameters has the following ratios.

p[r]={1,1.125,1.25,1.375,1.625,1.75}

If a quantization step when Qp=1 is p[1], a quantization step when Qp=2 has a value of 1.125*p[1], a quantization step when Qp=3 has a value of 1.25*p[1], a quantization step when Qp=4 has a value of 1.375*p[1], a quantization step when Qp=5 has a value of 1.625*p[1], and a quantization step when Qp=6 has a value of 1.625*p[1]. As described above, when the quantization parameter has increased by 6 stages from the case where Qp=1, that is, when Qp=7, a quantization step has a value of 2*p[1], that is it has doubled in value. To compensate for an error generated due to the difference between quantization steps, the prediction error calculation unit 422 calculates a value currQP-colQP which is a difference deltaQP between a quantization step currQP used during quantization of the current block and a quantization step colQP used during encoding of a reference block used in the determination of the prediction mode for the current block. The prediction error calculation unit 422 calculates a value q obtained by dividing the quantization step difference deltaQP by 6 and then rounding off a result of the division, and a value deltaQP % 6 being a quotient r obtained by the division of the quantization step difference deltaQP by 6. Then, the prediction error calculation unit 422 sets a value q+p[r] as a correction weight s. If the quantization step difference deltaQP is greater than 0, the prediction error calculation unit 422 maintains the original first error value without compensation of a quantization error. If the quantization step difference deltaQP is less than or equal to 0, the prediction error calculation unit 422 sets a product of the first error value and the correction weight s as a corrected first error value. If the quantization step difference deltaQP is greater than 0, the prediction error calculation unit 422 sets a product of the second error value and the correction weight s as a corrected second error value. If the quantization step difference deltaQP is less than or equal to 0, the prediction error calculation unit 422 maintains the second error value without compensation of a quantization error. Then, as described above, the second prediction mode candidate group determination unit 423 compares the corrected first error value with the corrected second error value and determines the second prediction mode candidate group.

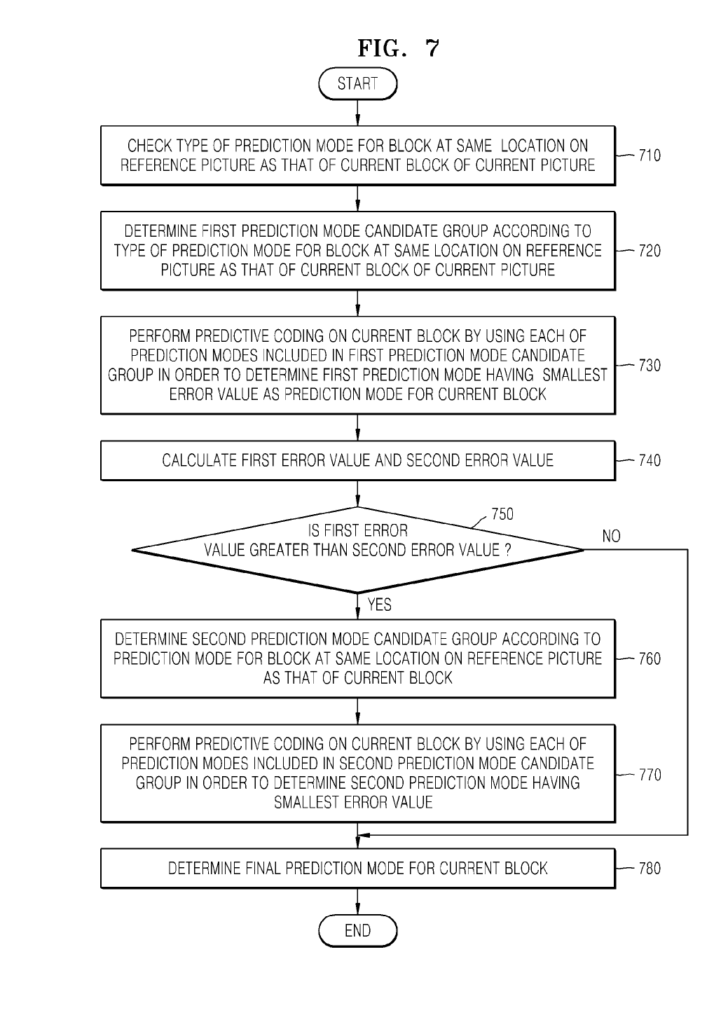

FIG. 7 is a flowchart of a prediction mode determining method according to an exemplary embodiment of the present invention. Referring to FIG. 7, in operation 710, the first prediction mode candidate group determination unit 421 checks the type of the prediction mode for the block at the same location on the reference picture as that of the current block of the current picture to be encoded.

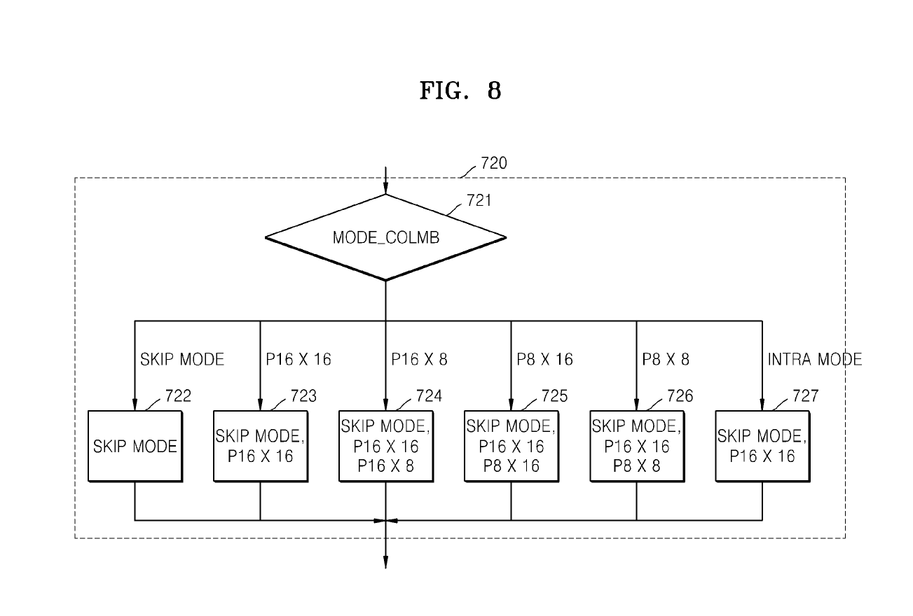

In operation 720, the first prediction mode candidate group determination unit 421 determines the first prediction mode candidate group to be actually applied for the current block, according to the type of the prediction mode for the block at the same location on the reference picture as that of the current block of the current picture which is encoded. FIG. 8 is a flowchart illustrating the first prediction mode candidate group determining operation 720 in greater detail. Referring to FIG. 8, in operation 721, the first prediction mode candidate group determination unit 421 checks the type of a prediction mode MODE_COLMB for the block at the same location on the reference picture as that of the current block of the current picture encoded. If the prediction mode MODE_COLMB is skip mode, then skip mode is determined as the component mode of the first prediction mode candidate group to be actually applied for the current block, in operation 722. If the prediction mode MODE_COLMB is an inter M×N (where M and N are integers) mode, the first prediction mode candidate group determination unit 421 determines skip mode and an interprediction mode(s) that uses a block with a size equal to or greater than a M×N block used in the inter M×N mode, as the component modes of the first prediction mode candidate group to be actually applied for the current block, in operations 723 through 726. If the prediction mode MODE_COLMB is an intra mode, the first prediction mode candidate group determination unit 421 determines skip mode and a P16×16 mode as the component modes of the first prediction mode candidate group to be actually applied for the current block, in operation 727. If the prediction mode MODE_COLMB is not any of the prediction modes listed in Table 1, the current block is predictively encoded by applying all available prediction modes as in the conventional art.

Referring back to FIG. 7, in operation 730, the encoding unit 410 performs predictive coding on the current block by using each of the prediction modes included in the first prediction mode candidate group, and the final prediction mode determination unit 424 determines the first prediction mode having the smallest error value from among the prediction modes included in the first prediction mode candidate group as a prediction mode for the current block.

In operation 740, the prediction error calculation unit 422 calculates the first error value between the prediction block for the current block obtained in the first prediction mode and the current block, and the second error value between the block at the same location on the reference picture as that of the current block and the prediction block used during encoding of the block at the same location on the reference picture as that of the current block.

In operation 750, the first error value is compared with the second error value. When the first error value is greater than the second error value, the second prediction mode candidate group determination unit 423 determines the second prediction mode candidate group to be additionally used for the current block, according to the prediction mode for the block at the same location on the reference picture as that of the current block, in operation 760. An exemplary embodiment of the second prediction mode candidate group depending on the type of the prediction mode for the block at the same location on the reference picture as that of the current block is illustrated in Table 1.

In operation 770, the encoding unit 410 performs predictive coding on the current block by using each of the prediction modes included in the second prediction mode candidate group, and the final prediction mode determination unit 424 determines a second prediction mode having the smallest error value from among the prediction modes included in the second prediction mode candidate group. In operation 780, the final prediction mode determination unit 424 determines a prediction mode corresponding to a prediction block having a smaller error value from among prediction blocks of the current block which are obtained in the first prediction mode and the second prediction mode, as the final prediction mode for the current block. The error value is a difference between the current block and a prediction block for the current block.

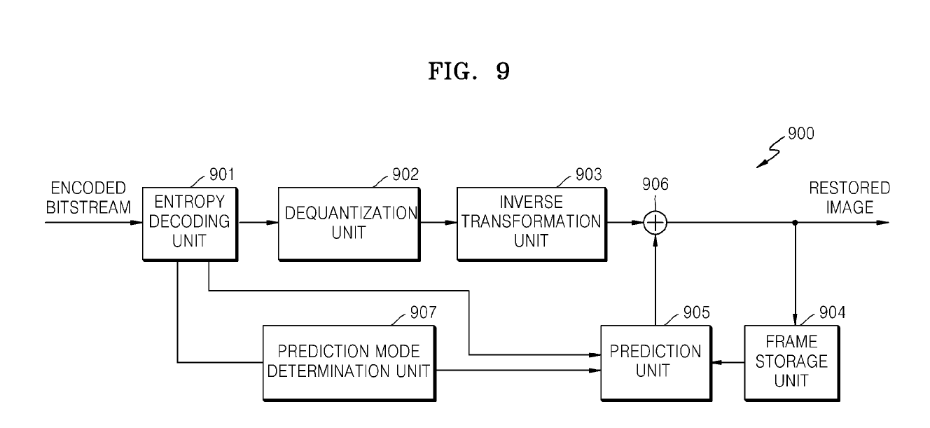

FIG. 9 is a block diagram of an image decoding apparatus 900 according to an exemplary embodiment of the present invention. Referring to FIG. 9, the image decoding apparatus 900 includes an entropy decoding unit 901, a dequantization unit 902, an inverse transformation unit 903, a frame storage unit 904, a prediction unit 905, an adder 906, and a prediction mode determination unit 907.

The entropy decoding unit 901 entropy-decodes an encoded bitstream and extracts prediction mode information and image data for a current block from the bitstream. The dequantization unit 902 dequantizes the entropy decoded image data and transmits the dequantized image data to the inverse transformation unit 903. The inverse transformation unit 903 inversely transforms the dequantized image data to restore a residual value.

The prediction mode determination unit 907 determines a prediction mode for the current block from the extracted prediction mode information and transmits information about the prediction mode to the prediction unit 905. The prediction unit 905 performs interprediction or intraprediction in the prediction mode for the current block and generates a prediction block of the current block.

The adder 906 adds the residual value to the prediction block of the current block to generate the restored image data. However, the addition of the residual value to the prediction block of the current block is performed in only prediction modes other than skip mode. In the case of skip mode, motion-compensated data itself is the restored image data. The frame storage unit 904 stores information about previously decoded pictures in order to use them when the next block is decoded.

The invention can also be embodied as computer readable codes on a computer readable recording medium, or a compute readable transmission medium. The computer readable recording medium and computer readable transmission medium may be any data storage device or structure that can store data which can be thereafter read by a computer system. Examples of the computer readable recording medium include read-only memory (ROM), random-access memory (RAM), CD-ROMs, magnetic tapes, floppy disks, and optical data storage devices. Examples of the computer readable transmission medium may be carrier waves (such as data transmission through the Internet). The computer readable recording medium and computer readable transmission medium may also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of determining a prediction mode for an image, the method comprising:
checking a reference prediction mode for a reference block positioned at a location on a reference picture that is the same as a location of a current block of a current picture to be encoded;
determining a first prediction mode candidate group to be used for the current block, according to a type of the reference prediction mode;
performing predictive coding on the current block using prediction modes included in the first prediction mode candidate group; and
determining a first prediction mode, having a smallest error value from among the prediction modes included in the first prediction mode candidate group, as a prediction mode to be used for the current block.

2. The method of claim 1, wherein in the determining of the first prediction mode candidate group:
if the reference prediction mode is skip mode, then the skip mode is determined as being included in the first prediction mode candidate group;
if the reference prediction mode is an inter M×N (where M and N are integers) mode, then the skip mode and an interprediction mode that uses a block having a size equal to or greater than M×N are determined as being included in the first prediction mode candidate group; and
if the reference prediction mode is an intra mode, then the skip mode and an inter 16×16 mode are determined as being included in the first prediction mode candidate group.

3. The method of claim 1, further comprising:
calculating a first error value between the current block and a prediction block of the current block, wherein the prediction block is obtained based on the first prediction mode;
calculating a second error value between the reference block and a prediction block used in encoding of the reference block;
if the first error value is greater than the second error value, determining a second prediction mode candidate group to be used for the current block, according to the type of the reference prediction mode;
performing predictive coding on the current block using prediction modes included in the second prediction mode candidate group;
determining a second prediction mode having a smallest error value from among the prediction modes included in the second prediction mode candidate group; and
determining a prediction mode having a smaller error value from among the first prediction mode having the smallest error value, and the second prediction mode having the smallest error value, as a final prediction mode for the current block,
wherein the error value is a difference between the current block and the prediction block for the current block.

4. The method of claim 3, wherein in the determining of the second prediction mode candidate group:
if the prediction mode of the reference block is skip mode, then an inter 16×16 mode is determined as a component mode of the second prediction mode candidate group;
if the prediction mode of the reference block is an inter P×Q (where P and Q are each individually 8 or 16) mode, then an intra mode and an inter 8×8 mode are determined to be included in the second prediction mode candidate group; and
if the prediction mode of the reference block is an intra mode, then the inter 8×8 mode and the intra mode are determined to be included in the second prediction mode candidate group.

5. The method of claim 3, wherein the determining of the second prediction mode candidate group further comprises:
calculating a correction weight used to compensate for a quantization error which is generated due to a difference between quantization steps used in predictive coding of the current block and predictive coding of the reference block; and
correcting the first error value and the second error value by using the correction weight.

6. The method of claim 3, further comprising:
generating residual data corresponding to a difference between the prediction block and the current block;
transforming and quantizing the residual data;
dequantizing and inverse transforming the transformed and quantized residual data to generate restored residual data;
adding the prediction block to the restored residual data to generate a restored current block; and
storing the restored current block so as to be used as a new reference block for a new current block.

7. The method of claim 1, wherein the error value is calculated using one of a sum of absolute difference (SAD), a sum of absolute transformed difference (SATD), a sum of squared difference (SSD), a mean of absolute difference (MAD), and a LaGrange function.

8. The method of claim 1, wherein the current picture is one of a B picture or a P picture.

9. The method of claim 8, wherein the current picture is the B picture at a highest layer in a hierarchical B picture structure.

10. An apparatus for determining a prediction mode for an image, the apparatus comprising:
a first prediction mode candidate group determination unit which determines a first prediction mode candidate group to be used for a current block of a current picture to be encoded, the first prediction mode candidate group being determined according to a type of a prediction mode of a reference block positioned at a location on a reference picture that is the same as a location of the current block of the current picture; and
a final prediction mode determination unit which determines a first prediction mode, having a smallest error value from among prediction modes included in the first prediction mode candidate group, as a prediction mode to be used for the current block, the first prediction mode being determined according to results of predictive coding operations on the current block based on the prediction modes included in the first prediction mode candidate group.

11. The apparatus of claim 10, wherein:
if the prediction mode of the reference block is a skip mode, then the first prediction mode candidate group determination unit determines the skip mode as being included in the first prediction mode candidate group;
if the prediction mode of the reference block is an inter M×N (where M and N are integers) mode, then the first prediction mode candidate group determination unit determines the skip mode and an interprediction mode that uses a block having a size equal to or greater than M×N, as being included in the first prediction mode candidate group; and
if the prediction mode of the reference block is an intra mode, then the first prediction mode candidate group determination unit determines the skip mode and an inter 16×16 mode as being included in the first prediction mode candidate group.

12. The apparatus of claim 10, further comprising:
a prediction error calculation unit which calculates a first error value between the current block and a prediction block of the current block, wherein the prediction block is obtained based on first prediction mode, and which calculates a second error value between the reference block and a prediction block used in encoding of the reference block; and
a second prediction mode candidate group determination unit which determines a second prediction mode candidate group to be used for the current block, according to the type of the prediction mode of the reference block, if the first error value is greater than the second error value,
wherein the final prediction mode determination unit determines a second prediction mode having a smallest error value from among the prediction modes included in the second prediction mode candidate group according to results of predictive coding operations on the current block using prediction modes included in the second prediction mode candidate group, and determines a prediction mode having a smaller error value from among the first prediction mode having the smallest error value and the second prediction mode having the smallest error value, as a final prediction mode for the current block, and
wherein the error value is a difference between the current block and the prediction block for the current block.

13. The apparatus of claim 12, wherein:
if the prediction mode of the reference block is a skip mode, then the second prediction mode candidate group determination unit determines an inter 16×16 mode as being included in the second prediction mode candidate group;
if the prediction mode of the reference block is an inter P×Q (where P and Q are each individually 8 or 16) mode, then the second prediction mode candidate group determination unit determines an intra mode and an inter 8×8 mode as being included in the second prediction mode candidate group; and
if the prediction mode of the reference block is an intra mode, then the second prediction mode candidate group determination unit determines the inter 8×8 mode and the intra mode as being included in the second prediction mode candidate group.

14. The apparatus of claim 12, wherein the prediction error calculation unit calculates a correction weight used to compensate for a quantization error which is generated due to a difference between quantization steps used in predictive coding of the current block and predictive coding of the reference block, and corrects the first error value and the second error value by using the correction weight.

15. The apparatus of claim 12, further comprising:
a subtracting unit which generates residual data corresponding to a difference between the prediction block and the current block;
a transforming and quantizing unit which transforms and quantizes the residual data;
a dequantizing and inverse transforming unit which dequantizes and inverse transforms the transformed and quantized residual data to generate restored residual data;
an adding unit which adds the prediction block to the restored residual data to generate a restored current block; and
a storing unit which stores the restored current block so as to be used as a new reference block for a new current block.

16. The apparatus of claim 10, wherein the error value is calculated using one of a sum of absolute difference (SAD), a sum of absolute transformed difference (SATD), a sum of squared difference (SSD), a mean of absolute difference (MAD), and a LaGrange function.

17. The apparatus of claim 10, wherein the current picture is one of a B picture or a P picture.

18. The apparatus of claim 17, wherein the current picture is the B picture at a highest layer in a hierarchical B picture structure.

19. An image decoding method comprising:
receiving a bitstream obtained by encoding based on a prediction mode which provides a smallest prediction error value from among prediction modes included in a prediction mode candidate group determined according to a prediction mode for a reference block at a location on a reference picture that is the same as a location of a current block on a current picture;
generating residual data for the current block by performing entropy decoding, dequantization, and inverse transformation on the received bitstream;
generating a prediction block for the current block by applying the prediction mode which provides the smallest prediction error value; and
decoding the current block by adding the current block to the prediction block.

20. The image decoding method of claim 19,
wherein the prediction mode candidate group comprises a first prediction mode candidate group,
wherein the first prediction mode candidate group includes a skip mode, if the prediction mode of the reference block is the skip mode,
wherein the first prediction mode candidate group includes the skip mode and an interprediction mode, if the prediction mode of the reference block is an inter M×N (where M and N are integers) mode, and
wherein the first prediction mode candidate group includes the skip mode and an inter 16×16 mode when the prediction mode of the reference block is an intra mode,
wherein the interprediction mode uses a block having a size equal to or greater than M×N,

21. The image decoding method of claim 20,
wherein the prediction mode candidate group further comprises a second prediction mode candidate group,
wherein the second prediction mode candidate group includes the inter 16×16 mode, if the prediction mode of the reference block is the skip mode,
wherein the second prediction mode candidate group includes the intra mode and the inter 8×8 mode, if the prediction mode of the reference block is an inter P×Q (where P and Q are each individually 8 or 16) mode, and
wherein the second prediction mode candidate group includes the inter 8×8 mode and the intra mode, if the prediction mode of the reference block is the intra mode.

22. An image decoding apparatus comprising:
an entropy decoding unit which receives a bitstream obtained by encoding based on a prediction mode which provides a smallest prediction error value from among prediction modes included in a prediction mode candidate group determined according to a prediction mode for a reference block at a location on a reference picture that is the same as a location of a current block and which performs entropy decoding on the received bitstream;
a dequantization and inverse transformation unit which generates residual data for the current block by performing dequantization, and inverse transformation on the entropy-decoded bitstream;
a prediction unit which generates a prediction block for the current block by applying the prediction mode which provides the smallest prediction error value, wherein the prediction mode is extracted from the bitstream; and
an addition unit which decodes the current block by adding the current block to the prediction block.

23. The image decoding apparatus of claim 22,
wherein the prediction mode candidate group comprises a first prediction mode candidate group,
wherein the first prediction mode candidate group includes a skip mode, if the prediction mode of the reference block is the skip mode,
wherein the first prediction mode candidate group includes the skip mode and an interprediction mode, if the prediction mode of the reference block is an inter M×N (where M and N are integers) mode,
wherein the first prediction mode candidate group includes the skip mode and an inter 16×16 mode, if the prediction mode of the reference block is an intra mode,
wherein the interprediction mode uses a block having a size equal to or greater than M×N,

24. The image decoding apparatus of claim 23,
wherein the prediction mode candidate group further comprises a second prediction mode candidate group,
wherein the second prediction mode candidate group includes an inter 16×16 mode, if the prediction mode of the reference block is the skip mode,
wherein the second prediction mode candidate group includes the intra mode and an inter 8×8 mode, if the prediction mode of the reference block is an inter P×Q (where P and Q are each individually 8 or 16) mode, and
wherein the second prediction mode candidate group includes the inter 8×8 mode and the intra mode, if the prediction mode of the reference block is the intra mode.

25. A computer-readable recording medium having recorded thereon a program for executing the method of claim 1.

26. A computer-readable recording medium having recorded thereon a program for executing the method of claim 19.
